(19) United States
(12) Patent Application Publication
(10) Pub. No.: US 2006/0244354 A1
(43) Pub. Date: Nov. 2, 2006

(54) Flat lamp assembly for backlight module

(76) Inventors: Yu-Chuan Lin, Hsin-Chu (TW); Chun-Yuan Chen, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/194,644

(22) Filed: Aug. 2, 2005

(30) Foreign Application Priority Data
Apr. 29, 2005 (TW) 094114059

(51) Int. Cl. H01J 5/48; H01J 5/50

(52) U.S. Cl. 313/318.01

(57) ABSTRACT

A flat lamp assembly for a backlight module is disclosed, and the flat lamp assembly comprises a flat lamp, and at least one buffer. The flat lamp has at least one contact surface and the buffer is disposed on the contact surface. Another flat lamp assembly comprises a flat lamp, a frame, and at least one buffer. The buffer is disposed on the frame in order to fix the flat lamp

### FIELD OF THE INVENTION

The present invention generally relates to a flat lamp assembly for a backlight module, and more particularly relates to a flat lamp assembly for a backlight module that using in liquid crystal displays (LCDs).

### BACKGROUND OF THE INVENTION

Liquid Crystal Display is now in widespread use in the flat display due to its characteristics with low power consumption, light weight, and thin slice. General speaking, liquid crystal is not the light-emitting diode; it must be a backlight of a light source to support the display device of the liquid crystal panel. In the optic field, the backlight must be displaying the brightness, the brightness with homogenous, a visual angle, and the color rendering. In the electric characteristics, the backlight must be presenting the low power consumption and the low noise. In the mechanical characteristics, the backlight must be showing the thin slice, the light weight, and the impact resistant.

Referring to FIG. 1, a sectional drawing of a flat lamp of a prior art flat lamp is illustrated. The flat lamp 11 is composed of an upper glass board 111, a discharge space 112, a downward glass board 113, and a glue frame 114. The discharge space 112 is formed between the upper glass board 111 and the downward glass board 113.

Referring to FIG. 2, another sectional drawing of a flat lamp of a prior art flat lamp is illustrated. The flat lamp 21 is composed of an upper glass board 211, a discharge space 212, and a downward glass board 213. The discharge space 212 is direct formed by the upper glass board 211 and the downward glass board 213.

Next, referring to FIG. 3, a sectional drawing of a flat lamp and a flat lamp support of a prior art flat lamp are illustrated. The support structure 31 are usually used to assemble the flat lamp 21 into to a backlight module, and the support structure 31 and the flat lamp 21 are usually fixed by screw 32. Furthermore, the four sides of the flat lamp 21 often produce cracks due to too many pressures from assembly. Besides, the function of the flat lamp may be fail and the backlight module may also break down in reliability testing due to thermal stresses accumulated. Therefore, there must be a solution to avoid the flat lamp to suffer damages from stresses or impacts in order to improve the production yield of the backlight module.

### SUMMARY OF THE INVENTION

Therefore, it is a primary objective of the present invention to provide a flat lamp assembly for a backlight module. The flat lamp assembly comprises a flat lamp and at least one buffer. The flat lamp has at least one contact surface and the buffer is disposed on the contact surface. The second object of the present invention is to provide another flat lamp assembly for a backlight module. The flat lamp assembly comprises a flat lamp, a frame, and at least one buffer. The buffer is disposed on the frame in order to fix the flat lamp. The feature is that the flat lamp assembly sets the buffer between the flat lamp and the frame, and the design could avoid the flat lamp to suffer damages through the buffer in assembly. The design also makes the flat lamp assembly to absorb thermal stresses and other impacts in reliability testing and the operating process. Furthermore, the buffer can be set on the flat lamp or the frame to provide more constriction capabilities in assembly and to decrease damages, so as to improve the production yield of the backlight module.

### BRIEF DESCRIPTION OF THE DRAWINGS

FIG. 1 is a sectional drawing of a flat lamp;

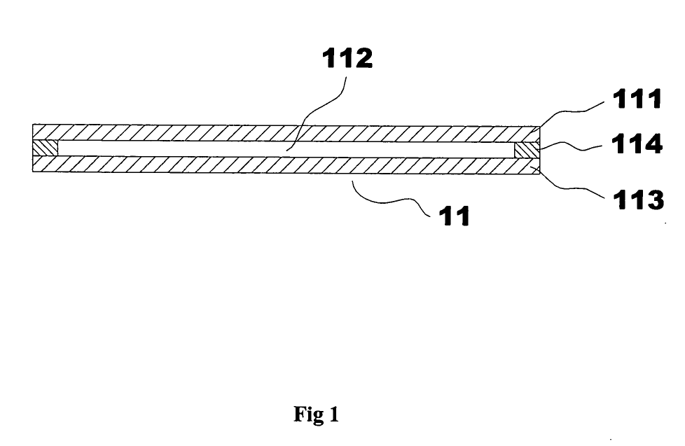

FIG. 2 is another sectional drawing of a flat lamp;

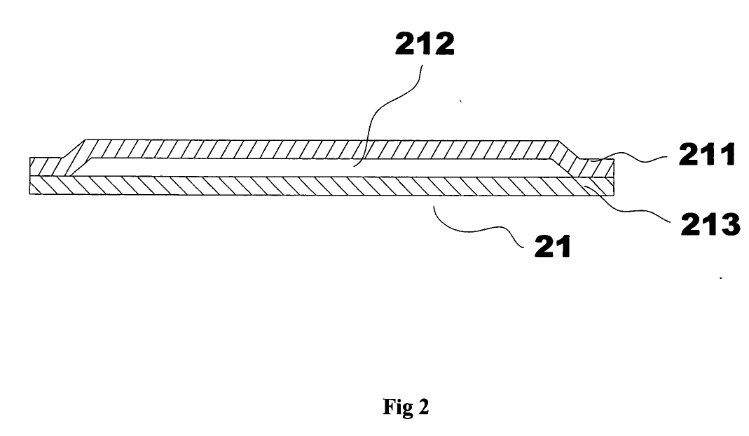

FIG. 3 is a sectional drawing of a flat lamp and a flat lamp support;

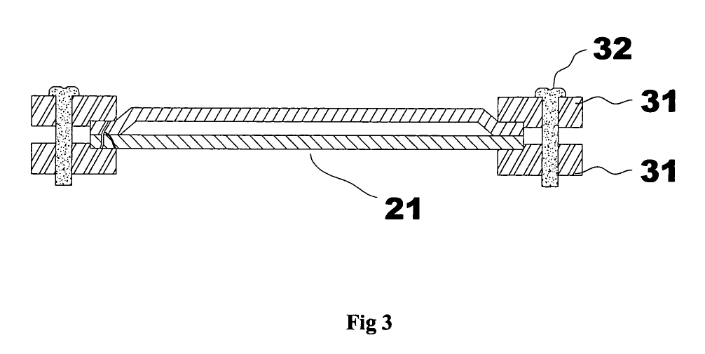

FIG. 4 is a block diagram of an example of a flat lamp assembly for a backlight module according to a preferred embodiment of the present invention.

FIG. 5 is another block diagram of an example of a flat lamp assembly for a backlight module according to a preferred embodiment of the present invention; and

FIG. 6 is another block diagram of an example of a flat lamp assembly for a backlight module according to a preferred embodiment of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

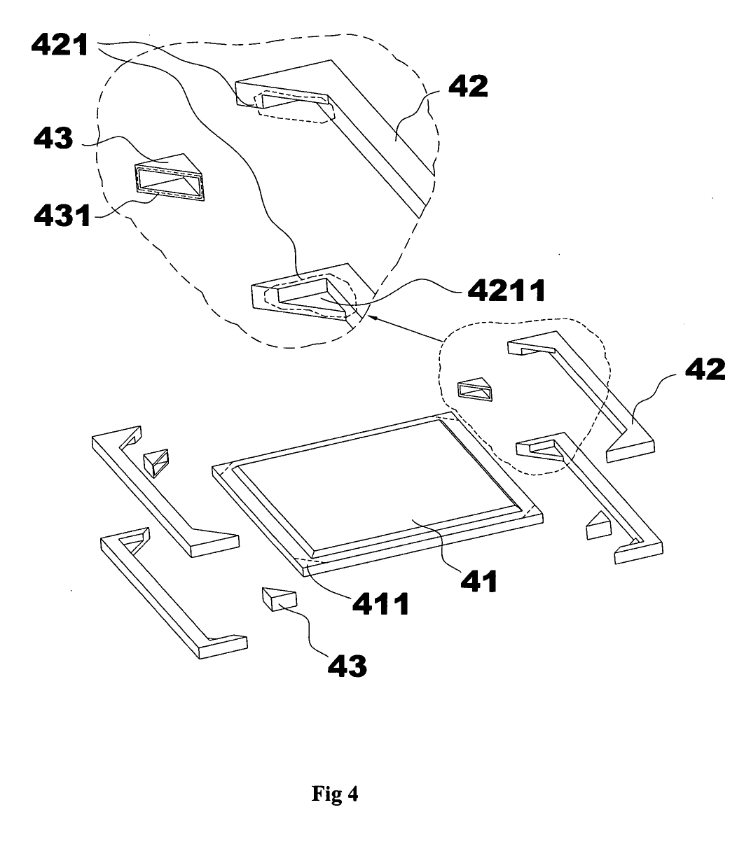

Referring to FIG. 4, a block diagram of an example of a flat lamp assembly for a backlight module according to a preferred embodiment of the present invention is illustrated. In the preferred embodiment, the flat lamp assembly comprises a flat lamp 41 and at least one buffer 43. The flat lamp 41 has at least one contact surface 411 and the buffer is disposed on the contact surface 411. The buffer 43 has a sheath 431 for coupling with the contact surface 411. The flat lamp assembly further comprises a frame 42 and the frame 42 further has a notch 421 for holding the flat lamp 41. The flat lamp 41 is set into the frame 42 and has at least one contact surface 411 at any sides of the flat lamp 41. At the same time, the buffer 43 is set on the contact surface. The flat lamp 41 is a flat lamp. The frame 42 is a flat lamp support structure. The buffer 43 is substantially made of a plastic pad, a silica gel, or a foam material. In the flat lamp assembly, the buffer 43 is disposed on the contact surface 411 between the flat lamp 41 and the frame 42.

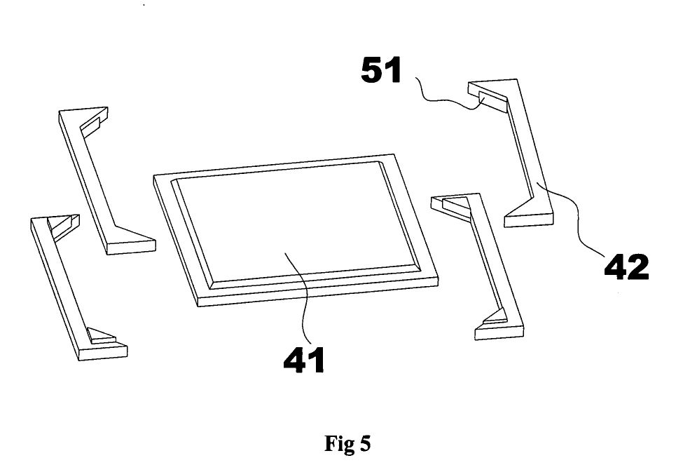

Referring to FIG. 5, another block diagram of an example of a flat lamp assembly for a backlight module according to a preferred embodiment of the present invention is illustrated. In the preferred embodiment, the flat lamp assembly comprises a flat lamp 41, a frame 42, and at least one buffer 51. The flat lamp 41 is set into the frame 42. The frame 42 further has a notch 421 and the buffer 51 is disposed on the frame 42 in order to fix the flat lamp 41. The buffer 51 is disposed on a contact surface 4211 of the notch 421 (as shown in FIG. 4). The frame 42 is a flat lamp support frame. The buffer 51 is substantially made of a plastic material, a silica gel, or a foam material. In addition, the notch 421 of the frame 42 can contain the flat lamp 41 in order to fix into the frame 42.

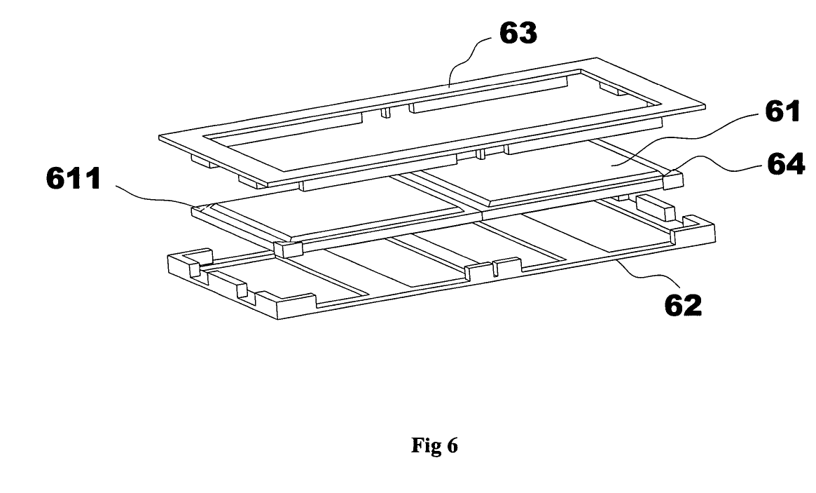

Referring to FIG. 6, another block diagram of an example of a flat lamp assembly for a backlight module according to a preferred embodiment of the present invention is illustrated. In the preferred embodiment, the flat lamp assembly comprises a flat lamp 61, a base 62, an upper lid 63, and at least one buffer 64. The flat lamp 61 is set on the base 62 and the upper lid 63 is set on the flat lamp 61. In other words, the flat lamp 61 is set between the base 62 and the upper lid 63. The flat lamp 61 is a two-flat light. The base 62 can be a support base and the upper lid 63 can be a lamp upper lid. The buffer 64 can be a plastic material, a silica gel, or a foam material. The buffer 64 is set on a contact surface 611 of the flat lamp 61 to reduce stresses from the base 62 and the upper lid 63 in assembly. Therefore, the buffer 64 has a sheath to cover any sides of the flat lamp 61.

As mentioned above, the buffer is set between the flat lamp and the corresponding support structure and the design could avoid the flat lamp to suffer damages through the buffer in assembly. The design also makes the flat lamp assembly to absorb thermal stresses and other impacts in reliability testing and the operating process. Furthermore, the buffer can be set on the flat lamp or the support structure to provide more constriction capabilities in assembly and to decrease damages in order to improve the production yield of the backlight module.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A flat lamp assembly for a backlight module, comprising:
a flat lamp having at least one contact surface; and
at least one buffer being disposed on said contact surface.

2. The flat lamp assembly of claim 1, wherein said at least one buffer has a sheath for coupling with said contact surface.

3. The flat lamp assembly of claim 1, further comprising a frame having a notch for holding said flat lamp and said at least one buffer.

4. The flat lamp assembly of claim 1, wherein said at least one buffer is substantially made of a plastic material.

5. The flat lamp assembly of claim 1, wherein said at least one buffer is substantially made of a silica gel.

6. The flat lamp assembly of claim 1, wherein said at least one buffer is substantially made of a foam material.

7. The flat lamp assembly of claim 1, wherein said frame comprises a base and said flat lamp is disposed on said base.

8. The flat lamp assembly of claim 7, wherein said frame further comprises an upper lid for holding said flat lamp on said base.

9. A flat lamp assembly for a backlight module, at least comprising:
a flat lamp;
a frame; and
at least one buffer being disposed on said frame in order to fix said flat lamp.

10. The flat lamp assembly of claim 9, wherein said frame further has a notch in order to set said at least one buffer on a contact surface of said notch.

11. The flat lamp assembly of claim 9, wherein the material of said at least one buffer is substantially made of a plastic material.

12. The flat lamp assembly of claim 9, wherein the material of said at least one buffer is substantially made of a silica gel.

13. The flat lamp assembly of claim 9, wherein the material of said at least one buffer is substantially made of a foam material.

14. The flat lamp assembly of claim 9, wherein said frame comprises a base, said flat lamp is disposed on said base.

15. The flat lamp assembly of claim 14, wherein said frame further comprises an upper lid for holding said flat lamp on said base.
